(19) United States
(12) Patent Application Publication
(10) Pub. No.: US 2021/0027028 A1
(43) Pub. Date: Jan. 28, 2021

(54) RFID TRACKING DEVICES, SYSTEMS, AND METHODS

(71) Applicant: Certified Technologies LLC, Houston, TX (US)

(72) Inventors: Jason Robert CORSER, Clearwater, FL (US); Mathew James SLOAN, Williamstown, WV (US); Jason Carl WILSON, Marietta, OH (US); Eric BAUMGARDT, Houston, TX (US)

(73) Assignee: Certified Technologies LLC, Houston, TX (US)

(21) Appl. No.: 16/915,526

(22) Filed: Jun. 29, 2020

Related U.S. Application Data
(60) Provisional application No. 62/867,735, filed on Jun. 27, 2019.

(51) Int. Cl. G06K 7/10; G06K 19/07; G06Q 10/08; E06B 11/00

(52) U.S. Cl. CPC G06K 7/10297; G06K 19/0723; G06K 2019/06253; E06B 11/00; G06Q 10/087

(57) ABSTRACT

Systems and methods for monitoring a location and/or status of equipment, tools, products, and/or vehicles using Radio Frequency Identification (RFID) technology are provided herein. A system may comprise a plurality of RFID tags, each RFID tag associated with one of a plurality of items, a database storing information about each item, and a gateway structure. The gateway structure may include an RFID reader that reads the RFID tags. When the RFID tag is read, information in the database may be dynamically updated. Such system may be used for asset management.

### CROSS-REFERENCE TO RELATED APPLICATIONS

This application claims the benefit of U.S. Provisional Application No. 62/867,735, filed on 27 Jun. 2019, and which application is incorporated herein by reference in its entirety.

### FIELD OF THE INVENTION

The present disclosure relates to novel and advantageous devices, systems, and methods for monitoring a location and/or status of equipment, tools, products, and/or vehicles. More particularly, the present disclosure relates to novel and advantageous devices, systems, and methods for using Radio Frequency Identification (RFID) technology to determine when tools, equipment, products, and/or vehicles are leaving or entering a particular area or facility. Such system may be used for asset management.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Asset management is a critical component of many industries, and managing and locating assets can present a variety of logistical challenges. Typically, asset management has relied primarily on spreadsheets, tracking equipment with barcode labels, and generally manually tracking the assets.

In many industries, it may be desirable to track the location or status of items or assets, such as tools, products, equipment, or vehicles. For example, where a truck carrying oilfield equipment is deployed to service an oilfield, it may be desirable to take an inventory of the truck contents before the truck is deployed and after the truck returns. Such inventorying may ensure that the truck is equipped with appropriate tools to service the oilfield. Such inventorying may further held identify whether all of the equipment that was deployed is later returned to help ensure that equipment is not lost.

Thus, there is a need in the art for an automated system for tracking items.

### SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a system for tracking items. The system comprises a plurality of RFID tags, a database, and a gateway structure. Each RFID tag may be associated with one of a plurality of items. The database may store, for each RFID tag, information about the item with which the RFID tag is associated, the including a location of the item. The gateway structure may be configured and sized to allow a vehicle to pass therethrough. The gateway structure may include a vertical portion and a horizontal portion extending from the vertical portion. At least one RFID reader may be arranged on the vertical portion or the horizontal portion and may be configured to scan RFID tags as they pass through the gateway structure. The system may be configured such that when an item passes through the gateway structure, the RFID reader reads the RFID tag and communicates to the database to update the location of the RFID tag.

The present disclosure, in another embodiment, relates to a further system for tracking items. The system comprises a plurality of RFID tags, a database, and a container. Each RFID tag may be associated with one of a plurality of items. The database may store, for each RFID tag, information about the item with which the RFID tag is associated. The container may be configured for containing the plurality of items and may include at least one RFID reader for scanning RFID tags as they are placed in or removed from the container.

The present disclosure, in another embodiment, relates to a method for tracking items. The method comprises providing a plurality of RFID tags and associating one of the RFID tags with each of a plurality of items. An identifier for each RFID tag, together with information about the item with which the RFID tag is associated, and a status, are stored in a database. A gateway device having one or more RFID readers and configured for scanning RFID tags that pass through the gateway device is provided. The method further comprises receiving an indication that a first RFID tag has passed through the gateway device and updating the status associated with the first RFID tag.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a conceptual diagram of a system of the present disclosure, according to one or more embodiments.

FIG. 2 is a front view of a gateway structure of the present disclosure, according to one or more embodiments.

FIG. 3 is a perspective view of a gateway structure of the present disclosure, according to one or more embodiments.

FIG. 4 is a perspective view of a container of the present disclosure, according to one or more embodiments.

### DETAILED DESCRIPTION

The present disclosure relates to novel and advantageous devices, systems, and methods for tracking or monitoring a location and/or status of items, such as tools, products, equipment, or vehicles. In particular a system of the present disclosure provides a system, such as an asset management system, using radio frequency identification (RFID) technology. More specifically, the system may use a plurality of RFID tags. The system uses electromagnetic fields to transmit data from an RFID tag to a reader, thereby providing asset location information.

In one embodiment, the system may include a plurality of RFID tags, or other scannable or readable tags, each arranged on and associated with one of a plurality of items. The system may include a plurality of RFID readers arranged to define a loop, arch, box, or wall of radio signals. As an item with an attached RFID tag pass through the loop, arch, box, or wall of radio signals defined by the RFID readers, one or more of the readers may scan the RFID tag. Upon sensing the tag, the one or more RFID readers may communicate with a platform or application, which may verify and/or update stored information associated with the RFID tag.

The system may use active or passive RFID tags. Passive RFID tags have no internal power source and are powered by the electromagnetic energy transmitted from an RFID reader. In contrast, active RFID tags are battery-operated and continuously broadcast their own signal. Active RFID tags may comprise transponders or beacons. In general, the system may use all passive RFID tags, all active RFID tags, or a combination of passive and active RFID tags. For example, passive RFID tags may be used on less valuable assets and active RFID tags may be used on more valuable assets. Or passive RFID tags may be used on larger, less easily lost assets and active RFID tags may be used on smaller, more easily lost assets. In some embodiments, active RFID tags with on-board sensors to track environmental parameters such as moisture levels, temperature, etc. may be used on certain assets.

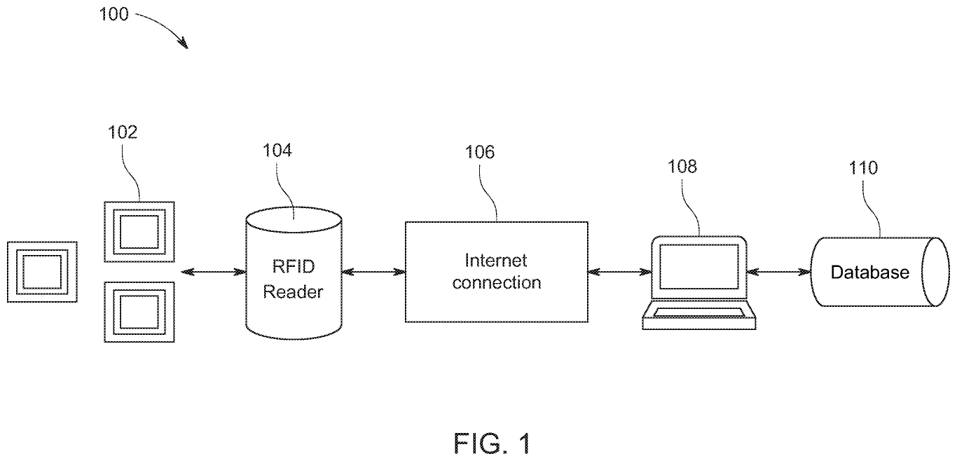

Turning now to FIG. 1, a system 100 of the present disclosure is shown. The system 100 may be an asset management system configured for tracking or monitoring a location and/or status of one or more items. Such items may include vehicles, equipment, tools, products, and/or other items. The system 100 may include one or more RFID tags 102. Each tag 102 may be arranged on or affixed to an item and may be configured for tracking the item to which it is affixed.

In general, the RFID tag may be an inlay or may be a hard tag. A hard RFID tag may be formed of plastic, metal, ceramic, or rubber, for example. Depending on the use, the RFID tags may be resistant to high temperatures, may be rugged such that they can withstand snow and ice, dust and debris, etc. If used for tracking metal assets, it may be desirable to use ultra-high frequency (UHF) metal-mount tags to mitigate problems UHF RFID faces around metal. If a tracked item is subject to significant wear and tear, a hard tag may be embedded in a small crevice and covered in epoxy to increase the lifespan of the tag. In some embodiments, the RFID tag may be encased in a rugged shell. An inlay RFID tag may be a dry inlay, a wet inlay, or a paper face tag.

In one embodiment, each tag 102 may be a passive RFID tag readable by an RFID reader. Each tag 102 may include a chip and antenna. Each tag 102 may include electronically-stored information. For example, each tag 102 may have stored therein an identifier, such as an alpha, a numerical or, an alphanumeric identifier. Additionally or alternatively, each tag 102 may store a name, description, and/or details about the item to which the tag is affixed. Tags 102 may be affixed to items using any suitable attachment means. For example, a tag 102 may be affixed to an item with an adhesive material. In some embodiments, each RFID tag 102 may be or include a sticker or label with an inlay storing information and readable by an RFID reader. In some embodiments, however, tags 102 may be embedded in or arranged inside items.

In some embodiments, the RFID tag may have a physical indicator of what item it is to be associated with. For example, a red RFID tag may be used to identify a first type of tool, a yellow RFID tag may be used to identify a second type of tool, a blue RFID tag may be used to identify a third type of tool, etc. A user thus may move an RFID tag from one item to another if it is no longer necessary to track the first item. While color is used as an example as a physical indicator, it is to be appreciated that any suitable method for physically identifying the tag may be used including text, graphics, numbers, etc.

The system 100 may further include a database 110. The database 110 may store information for each of the one or more RFID tags 102 and/or each of the items associated with the tags. In particular, the database 110 may store an identifier, such as an alpha, a numerical, or an alphanumeric identifier, associated with each RFID tag 102. It is to be appreciated that such identifier may or may not be displayed on the RFID tag. Additionally, for each RFID tag 102, the database 110 may store information about an item associated with the RFID tag 102. For example, where a first RFID tag 102 is affixed to a drill, the database 110 may identify the drill in association with an identifier of the RFID tag. In some embodiments, the database 110 may include a name, description, and/or details about the items, such as manufacturer, size, color, and/or other details. The database 110 may further store a status and/or location for each RFID tag 102. The location may be a geographic location, for example. The status may be a status of “in stock” or “on job site,” or another status. The status may include a date and/or time, such as a checkout date and time. The status may be dynamically updated when an RFID tag is read. In some embodiments, the database 110 may be searchable by item name, description, or details, by RFID identifier, or by status or location. The database 110 may include one or more local or remote databases. In some embodiments, the database 110 may be a cloud-based database.

The system 100 may additionally include one or more RFID readers 104 configured for scanning the RFID tags 102. Each RFID reader 104 may be configured to transmit a radio signal to interrogate the tags. As a tag 102 passes within range of the radio signal transmitted by the reader 104, the tag may respond by providing its encoded information to the reader. In some embodiments, the system 100 may include a plurality of readers 104. The multiple readers 104 may be positioned strategically to form a loop, box, or arch of emitted radio waves, such that when an RFID tag 102 passes through the wall, box, or arch, at least one of the RFID readers is likely to capture the tag information.

The one or more RFID readers 104 may be communicably coupled to the database 110 via a wired or wireless connection, such as an internet 106 connection. Any suitable type of connection may be used including, for example, satellite, Ethernet, wireless, Bluetooth tethering, or cellular networks. In some embodiments, an application or platform, which may be a web-based application or platform 108, may be configured for managing communication between the one or more readers 104 and the database(s) 110. For example, the platform or application 108 may be configured for receiving information from a reader 104 when a reader identifies an RFID tag 102. The reader 104 may send the encoded information from the tag 102 to the application or platform 108 via the internet connection or other connection 106. The application or platform 108 may further be configured to search the database 110 for information associated with the RFID tag 102. Moreover, the application or platform 108 may be configured to dynamically update a stored status and/or location associated with the RFID tag 102.

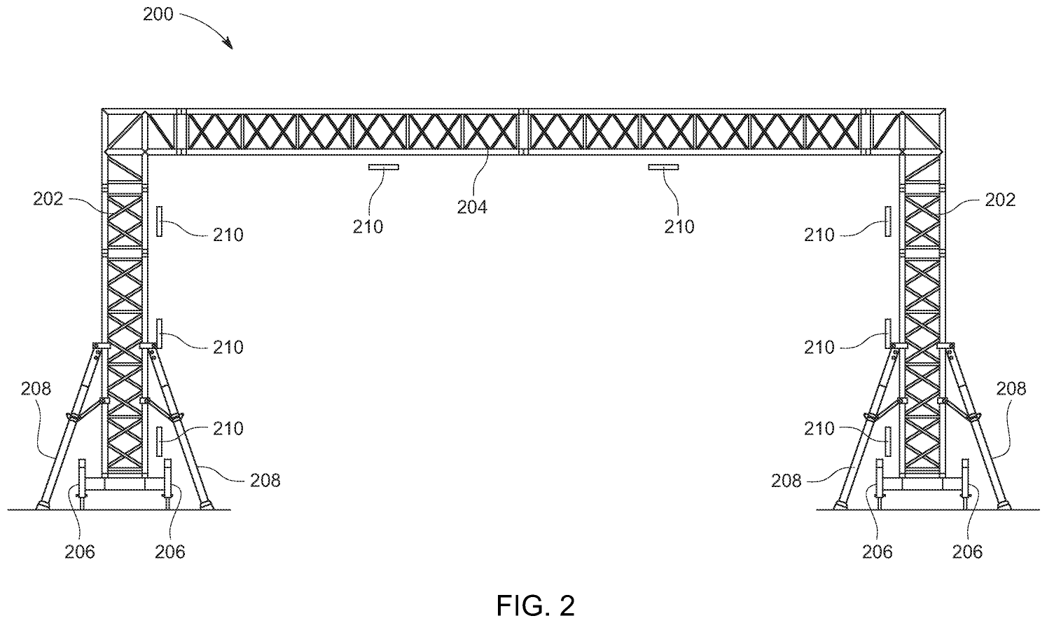

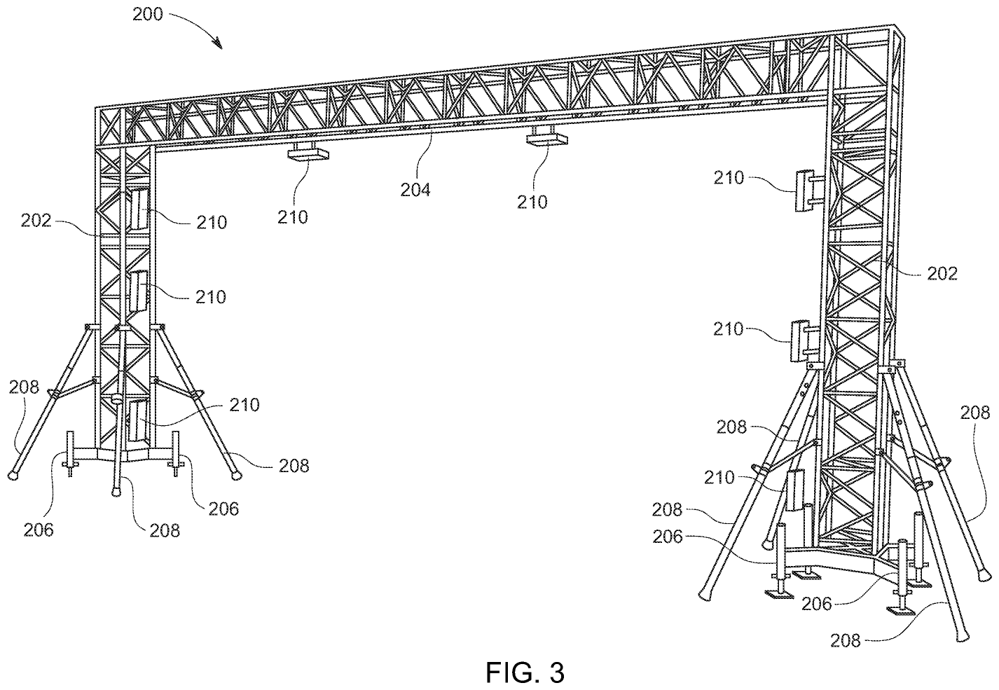

As described above, the one or more RFID readers 104 may be arranged in a loop, wall, box, or arch configuration in some embodiments, so as to improve the likelihood of capturing RFID tag information passing therethrough. For example, in some embodiments, the one or more readers may be arranged on an RFID gateway. FIGS. 2 and 3 show one embodiment of a gateway 200 of the present disclosure. The gateway 200 may include a structure configured for arranging a plurality of RFID readers in an arch or loop formation, such that RFID tags passing through the gateway may be readily captured by one or more of the readers. The gateway may include any suitable number of RFID readers. For example, the gateway may include between one and eight RFID readers. While discussion is specifically made of a plurality of RFID readers, in alternative embodiments, a single RFID reader with multiple antennas may be used. Moreover, in some embodiments, the gateway 200 may be sized and configured such that a person may walk through the gateway and/or may be sized and configured such that a vehicle may drive through the gateway.

In various embodiments, the gateway may have one or more vertical portions and/or one or more horizontal portions. In general, the more portions of the gateway that are provided, the more likely one is to capture all RFID tags passing through the gateway. In the embodiment show in FIGS. 2 and 3, the gateway has 3 portions—two vertical and one horizontal. In other embodiments, the gateway may have two portions, for example two vertical, two horizontal, or one vertical and one horizontal. In another embodiment, the gateway may have four portions, two vertical and two horizontal. In some embodiments, one portion, such as one vertical or one horizontal, may be sufficient.

As shown in FIGS. 2 and 3, the gateway 200 may include two vertical portions 202, also referred to as column portions, and one horizontal portion 204 extending between the column portions. In the embodiment shown, the horizontal portion 204 is an overhead portion. It is to be appreciated that, in an alternative embodiment, the horizontal portion may be a lower portion. Further, in some embodiments, both an overhead portion and a lower portion may be provided. Such lower portion may be, for example, sunk in the ground or overlaid with protective material. The column portions 202 may be configured to extend upward from a ground surface with a height configured such that a person and/or vehicle may pass beneath the overhead portion 204. The two column portions 202 may be spaced apart from one another with a distance configured to accommodate a person and/or a vehicle passing there between. In some embodiments, the gateway 200 may be configured such that a semi-trailer truck may pass through the gateway. Each of the column portions 202 and the overhead portion 204 may be constructed of a plurality of frame members, such as steel or aluminum frame members.

While FIGS. 2 and 3 illustrate the gateway 200 as a braced structure, it is to be appreciated that the column portions may comprise, for example, simple posts. Further, one or both columns may be a wall of an existing structure with RFID readers 210 attached thereto, as described below with respect to column portions 202.

The gateway 200 may have one or more RFID readers 210 arranged on the first and/or second column portions 202 and/or overhead portion 204 and/or lower portion. For example, as shown in FIGS. 2 and 3, three RFID readers 210 may be arranged on each column portion 202 and two RFID readers may be arranged on the overhead portion 202. In other embodiments, more or fewer RFID readers 210 may be arranged on each section of the gateway 200. In still other embodiments, the gateway 200 may have RFID readers 210 only on the overhead portion 204, the lower portion, or one or more column portions 202. It is to be appreciated that the readers 210 may form a loop, arch, or wall of radio waves. That is, when an RFID tag passes through the gateway (i.e. between the column portions 202 and beneath the overhead portion 204), the RFID tag may be scanned by one or more of the readers 210.

In some embodiments, each vertical portion 202 may have one or more adjustable feet 206 configured to help position and/or level the vertical portion on a ground surface. For example, each adjustable foot 206 may have a jackscrew for lengthening or shortening a portion of the foot. In some embodiments, the gateway 200 may have one or more outriggers 208 configured to help secure the structure. For example, one or more outriggers 208 may be configured to couple to each column portion 202 and extend between the column portion and the ground surface at an angle.

In some embodiments, the gateway 200 may be configured to be mobile. The column portions 202 may separate from the overhead portion 204 in some embodiments. Moreover, the column portions 202 and overhead portion 204 may be separable into multiple components that may configured to be snapped, screwed, clamped, or otherwise secured together with relative ease.

In use, systems and devices of the present disclosure may be used to track a location and/or status of items, such as tools, equipment, products, vehicles, or other items. In particular, systems and devices of the present disclosure may allow for relatively large-scale monitoring of assets or items without the need to scan each individual item manually before it is loaded onto a vehicle. Such systems and devices may additionally help to automate communication and increase efficiency of work flows by automatically updating a database and/or sending a notification when an item leaves or arrives at a facility or location.

As a particular example, a gateway of the present disclosure may be set up at or near an access point of an equipment storage facility. Equipment stored in the facility may have affixed RFID tags. When equipment items pass through the gateway, such as when they are being transported into or out of the storage facility, the RFID readers of the gateway may identify the equipment being transported. When equipment leaves the facility, a status associated with the equipment may be updated to identify that the equipment has been checked out or is in use. When the equipment returns to the facility, a status associated with the equipment may be updated to reflect that the equipment is at the facility or is checked in.

In some embodiments, an RFID tag of the present disclosure may be associated with multiple items. For example, a box or bin of items may have an RFID tag arranged thereon, the RFID tag associated with and configured to identify a plurality of items stored in the box or bin. In this way, a user may load such a box or bin onto a truck, and by driving the truck through the gateway, a database may be automatically updated to reflect that all of the items in the bin are in use.

In some embodiments, items may be associated with a particular user upon check out or check in. For example, a particular user's vehicle may have an RFID tag associating the vehicle with that user. When the user loads the vehicle with tagged items and drives the vehicle through the gateway, the database may be updated to reflect that that particular user has checked out or taken the tagged items. In this way, a status for each item may be updated to reflect which user or which vehicle is currently associated with the item.

In some embodiments, systems, devices, and methods of the present disclosure may be used in combination with location tracking systems and methods. For example, a vehicle may have an RFID tag and may additionally be configured to communicate global positioning system (GPS) data to the platform or application. In this way, the platform or application may monitor a location of all of the tagged items onboard the vehicle once they pass through the gateway. As a particular example, a company has a truck about to leave its facility and head to an active operation location. As the truck leaves the facility and drives through the gateway, the truck's RFID tag may be scanned and all of the tagged items on that truck may be scanned. The platform or application may recognize the relationship between the truck and items, and may associate the truck's RFID tag with the RFID tags of the items. The platform or application may receive location data from that truck, which may also provide a real-time location for all the items now associated with the truck. Someone in the field or office could be tracking all those items and make well informed decisions based on where those items are, and when they will arrive.

The web-based application or platform 108 track equipment through RFID tags. The database 100 may further be programmed with expected transfer dates or locations for equipment such that an alert may be generated when equipment is not scanned by an RFID reader at the expected location on the expected date. For example, if it is expected that a piece of equipment will be transported from Location A to Location B as part of a load and that piece of equipment does not scan out at Location A, an alert may be generated by the web-based application or platform 108 to direct the driver back to Location A. Similarly, in some embodiments a mobile RFID reader may be provided with the season such that a user can scan a load with the mobile RFID reader to ensure that the load has all scheduled items.

A method for tracking items is provided. The method comprises providing a plurality of RFID tags and associating one of the RFID tags with each of a plurality of items. An identifier for each RFID tag, together with information about the item with which the RFID tag is associated, and a status, are stored in a database. A gateway device having one or more RFID readers and configured for scanning RFID tags that pass through the gateway device is provided. The method further comprises receiving an indication that a first RFID tag has passed through the gateway device and updating the status associated with the first RFID tag. A location of the item may be dynamically updated when the gateway device scans the RFID tag associated with the item. In some embodiments, the method may further comprise receiving an indication when an expected RFID tag does not pass through the gateway device and generating an alert that an item associated with the expected RFID tag is missing.

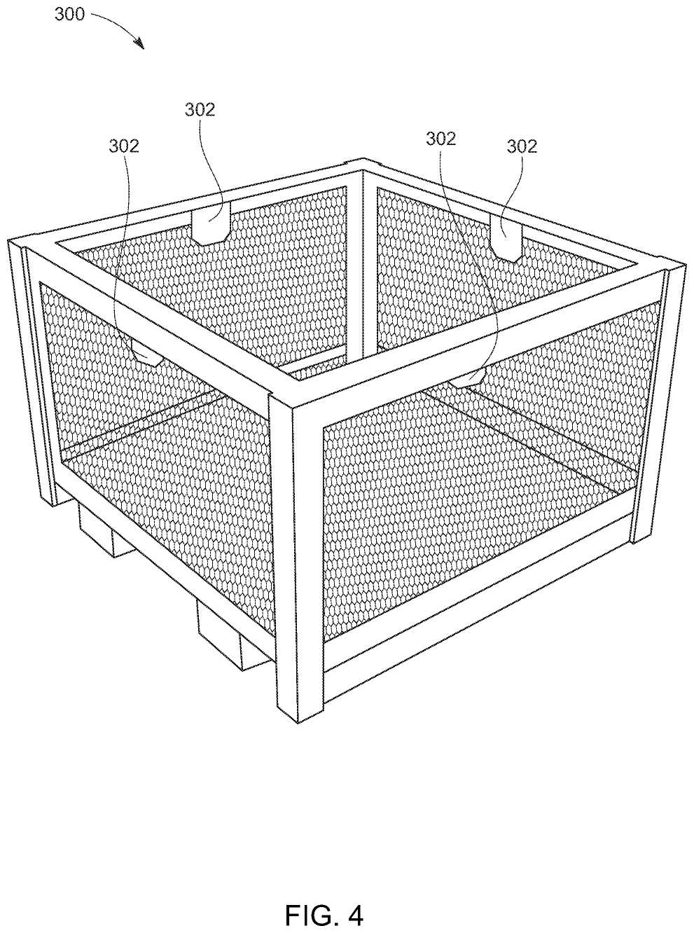

In some embodiments, RFID readers of the present disclosure may be arranged on a different structure, other than a gateway. For example, FIG. 4 shows an embodiment of a container 300 having a plurality of RFID readers 302 arranged therein. The RFID readers 302 may be configured to scan tagged items as the items are placed within, or removed from, the container 300. In some embodiments, the RFID readers 302 may be arranged on the container 300 so as to create a loop, wall, or box of radio waves through which tagged items may be passed to enter or exit the container. For example, where the container 300 has a rectangular or cubic shape, the container may have a floor or bottom portion and four wall portions extending therefrom. An RFID reader 302 may be arranged on each of the four wall portions. An upper edge of the four wall portions may define an opening of the container 300. In some embodiments, the container 300 may have a lid, but in other embodiments, the container may be open. The RFID readers 302 may be arranged near an upper edge or lip of the wall portions, so as to define a wall of radio waves at or near an opening of the container. In one embodiment, the container 300 of FIG. 4 may be used for tracking a plurality of iron items such as pipes, joints, valves, etc.

In some embodiments, active RFID tags may be used, such that each RFID tag may have a battery or other power source. In some embodiments, the RFID readers may be passive, such that the reader may respond to a signal emitted by an active tag without the need for first transmitting an interrogating signal. In other embodiments, barcodes may be used instead of RFID tags, and a gateway device or container of the present disclosure may have a plurality of barcode scanners arranged thereon. In still other embodiments, other readable or scannable devices, labels, or tags may be used.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A system for tracking items, the system comprising:
a plurality of RFID tags, each RFID tag associated with one of a plurality of items;
a database storing, for each RFID tag, information about the item on which the RFID tag is associated, the information including a location of the item; and
a gateway structure configured to allow a vehicle to pass therethrough, the gateway structure comprising:
a vertical portion;
a horizontal portion extending from the vertical portion; and
at least one RFID reader arranged on the vertical portion or the horizontal portion, and configured to scan RFID tags as they pass through the gateway structure;
wherein, when an item passes through the gateway structure, the RFID reader reads the RFID tag and communicates to the database to update the location of the RFID tag.

2. The system of claim 1, wherein the RFID reader communicates to the database via a platform and wherein the database is dynamically updated when the RFID read reads an RFID tag.

3. The system of claim 1, wherein the information includes a status of the RFID tag.

4. The system of claim 1, wherein at least one RFID reader is arranged on each of the vertical portion and the horizontal portion, and wherein the RFID readers define a wall of radio waves extending across the gateway structure.

5. The system of claim 1, wherein the horizontal portion is an overhead portion.

6. The system of claim 1, wherein the horizontal portion is a lower portion.

7. The system of claim 1, wherein the RFID tags are passive RFID tags.

8. The system of claim 1, wherein at least one of the RFID tags is an active RFID tag.

9. The system of claim 1, wherein the RFID tags are hard tags.

10. The system of claim 1, wherein each RFID tag includes a physical indicator of the item with which it is associated.

11. The system of claim 1, wherein each RFID tag is affixed to the item with which it is associated.

12. The system of claim 1, wherein the gateway structure comprises one or more outriggers extending from the column portion.

13. A system for tracking items, the system comprising:
a plurality of RFID tags, each RFID tag associated with one of a plurality of items;
a database storing, for each RFID tag, information about the item with which the RFID tag is associated; and
a container configured for containing the plurality of items, the container comprising at least one RFID reader configured to scan RFID tags as they are placed in or removed from the container.

14. The system of claim 13, wherein the container comprises a floor and four walls, and wherein at least one RFID reader is arranged on each of the four walls.

15. The system of claim 14, wherein the RFID readers define a wall of radio waves at an opening of the container.

16. The system of claim 13, wherein the database is dynamically updated when the RFID reader scans an RFID tag.

17. A method for tracking items, the method comprising:
providing a plurality of RFID tags;
associating one of the RFID tag with each of a plurality of items;
storing, in a database, an identifier for each RFID tag together with information about the item with which the RFID tag is associated and a status;
providing a gateway device having one or more RFID readers and configured for scanning RFID tags that pass through the gateway device;
receiving an indication that a first RFID tag has passed through the gateway device; and
updating the status associated with the first RFID tag.

18. The method of claim 17, further comprising:
receiving an indication that a second RFID tag has passed through the gateway device, the second tag associated with a vehicle; and
associating the first RFID tag with the second RFID tag.

19. The method of claim 17, wherein a location of the item is updated when the gateway device scans the RFID tag associated with the item.

20. The method of claim 17, further comprising receiving an indication when an expected RFID tag does not pass through the gateway device and generating an alert that an item associated with the expected RFID tag is missing.
